(19) United States
(12) Patent Application Publication
(10) Pub. No.: US 2015/0088909 A1
(43) Pub. Date: Mar. 26, 2015

(54) SYSTEM AND METHOD FOR CREATING A SCORED DEVICE ASSOCIATION GRAPH

(71) Applicant: BLUECAVA, INC., Irvine, CA (US)

(72) Inventors: Andres Corrada, Watertown, MA (US); David Tannenbaum, Port Washington, NY (US)

(21) Appl. No.: 14/492,642

(22) Filed: Sep. 22, 2014

Related U.S. Application Data
(60) Provisional application No. 61/881,142, filed on Sep. 23, 2013.

(51) Int. Cl. G06Q 30/02; G06F 17/30

(52) U.S. Cl. CPC G06Q 30/0254; G06F 17/3053
USPC 707/749

(57) ABSTRACT

A system and method for creating a scored association map that works in conjunction with advertisement serving technologies to enable multi-screen advertising. The method according to an embodiment of the disclosed subject matter comprises the steps of: (i) the creation of a scored association graph utilizing multiple data elements, (ii) allowing users to synchronize identifiers with the graph, and (iii) enabling users to retrieve elements and data from the graph and via an interface.

### CROSS-REFERENCE TO RELATED APPLICATIONS

The present application claims priority to U.S. Provisional Application No. 61/881,142, filed Sep. 23, 2013, the disclosure of which is hereby incorporated by reference in its entirety.

### BACKGROUND

1. Field of the Invention

The present disclosed subject matter relates generally to a method to score and link individual devices (e.g., AppBrowsers) together statistically. More specifically, the present disclosed subject matter is a system and method for creating a graph of devices, screens, consumers and households for the purpose of measuring and targeting on-line advertising.

2. Description of the Related Art

Advertising on the internet is a very large industry. Advertisers are interested in targeting very specific individuals who are most likely to engage with their product. Advertisers are often looking to target specific users or households who match certain demographics and/or have visited certain websites or purchased specific items. In order to reach those specific users, advertisers can utilize real-time bidders and exchanges that have access to large amount of inventory so they can find those specific users.

However, the bidders' knowledge of the user is limited to the specific device from which the ad request was made. There is no current graph that can associate a single device (e.g., AppBrowser) to all the associated screens (i.e., physical devices with a display) for the user.

As users utilize multiple internet connected devices simultaneously to interact with the same website or application, there is an opportunity to increase user engagement by advertising across multiple devices. Therefore, a need exists in the art to address the shortcomings of the current ad serving systems.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, methods to provide a system and method for creating a scored device association graph are disclosed.

In accordance with another aspect of the disclosed subject matter, computer systems are disclosed. An exemplary computer system can include at least one processor. At least one computer readable medium can be operatively coupled to the at least one processor. A logic can (i) execute in the at least one processor from the at least one computer readable medium and (ii) when executed by the at least one processor, cause the computer system to creating a scored device association graph. In accordance with another aspect of the disclosed subject matter, non-transitory computer readable storage media are disclosed. An exemplary non-transitory computer readable storage medium can include a set of executable instructions.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

Other systems, methods, features and advantages of the disclosed subject matter will be or will become apparent to one with skill in the art upon examination of the following figures and detailed description. It is intended that all such additional systems, methods, features, and advantages be included within this description, be within the scope of the disclosed subject matter, and be protected by the accompanying claims. Component parts shown in the drawings are not necessarily to scale, and may be exaggerated to better illustrate the important features of the disclosed subject matter. In the drawings, like reference numerals designate like parts throughout the different views, wherein:

FIG. 1 illustrates an object in JSON format that describes the hierarchy of a household.

FIG. 2 illustrates a block diagram of an exemplary process for calculating the association score for each edge of the graph.

FIG. 3 illustrates a block diagram of an exemplary process for accessing information (both reporting and individual nodes) from the graph.

FIG. 4 illustrates a block diagram of an exemplary process for attaching both common identifiers and segments to the graph nodes.

FIG. 5 illustrates a block diagram of the hierarchical view of a consumer household.

It is to be understood that the attached drawings are for purposes of illustrating the concepts of the disclosed subject matter and are not intended to be limiting in terms of the range of possible shapes and/or proportions.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

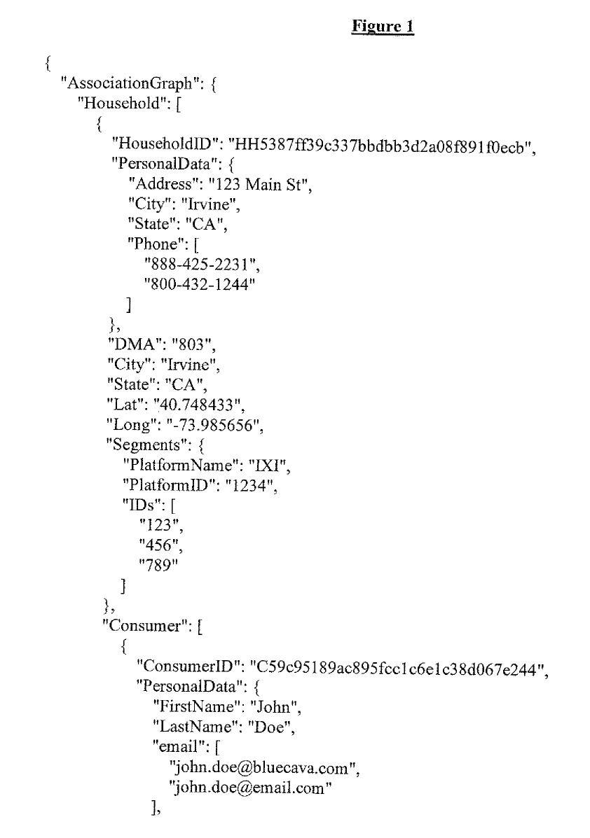

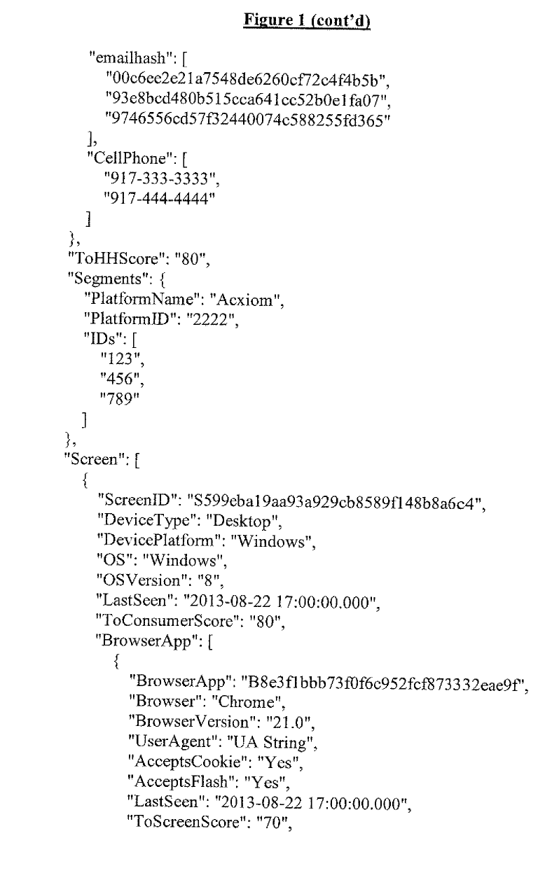

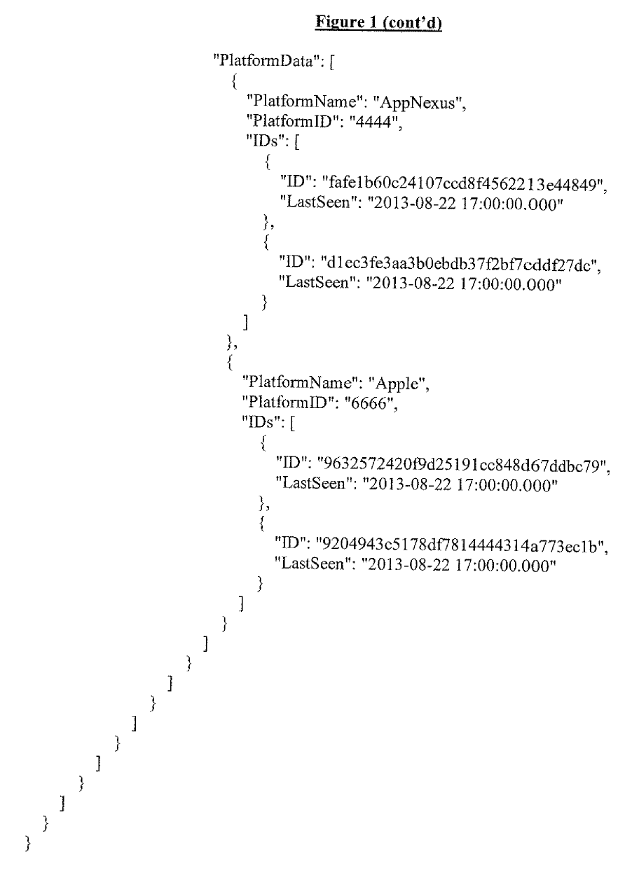

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, exemplary embodiments of methods, systems, and media to create a scored device association graph in accordance with the disclosed subject matter are shown in FIGS. 1-4. While the present disclosed subject matter is described with respect to using the methods, systems, and media for creating a scored device association graph, one skilled in the art will recognize that the disclosed subject matter is not limited to the illustrative embodiments.

With respect to the following disclosures, the following definitions are instructive:

BrowserApp: A single browser or application on a screen or device. A screen contains one or many browsers or applications that may request data, such as advertisements.

Screen: A physical device with a display (e.g., a desktop computer, tablet or mobile phone).

Consumer: A person who can be identified by having multiple screens.

Household: A group of consumers associated with each together.

API: Application Programming Interface.

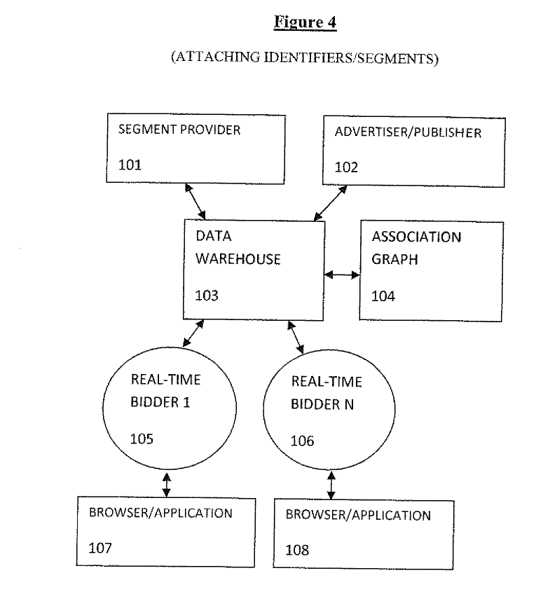

According to an embodiment of the disclosed subject matter and referring to FIG. 1, the object represented describes a household represented by a single consumer with a single screen containing a single browser. Households, consumers, and screens may contain one or many of their child elements. For example: a household could contain one or more consumers; a consumer could have one or more screens; and a screen could contain one or more browsers. Each child element contains a score that represents the strength of association of the child element to the parent. For example, in the JSON (JavaScript Object Notation) object in FIG. 1, the score of 80 (ToHHScore) represents an 80 percent probability that the consumer is indeed a member of its parent household. Additionally, data elements and segments can be attached to both the consumer and household objects representing data that is acquired through consumers opting in to sharing their data for marketing purposes. The BrowserApp nodes have attached to them common marketing identifiers from the advertising ecosystem. These common identifiers are contained in the PlatformData array. There may be one or many identifiers to the BrowserApp object. FIG. 4 illustrates one embodiment for the process of attaching these common identifiers to the BrowserApp.

According to an embodiment of the disclosed subject matter and referring to FIG. 2, the association between BrowserApps and Households can be carried out in a joint fashion as follows. The IP addresses in the Data Warehouse 114 are grouped by IP address type (e.g., DSL, Cable, Mobile, etc.) and the properties of the IP address type are derived from the data at 112. This includes the typical time an IP type is localized to a single router. Impressions connected to a single IP address and their corresponding BrowserApps are extracted from the Data Warehouse 114 guided by the properties of the IP type. For example, if the typical time a DSL IP address is connected to single router is 30 days, that time window is used to extract data for each IP address of the DSL type. The time pattern of the appearance of new BrowserApps at 111 is used to calculate a score for an IP address being a household. The time pattern of impressions at 113 is used to calculate a score for the IP address being a household. The scores and properties from 111, 112 and 113 are used to identify IP addresses likely to be a household location at 110. The BrowserAppIds are then associated with the unique Household objects they appear in FIG. 1.

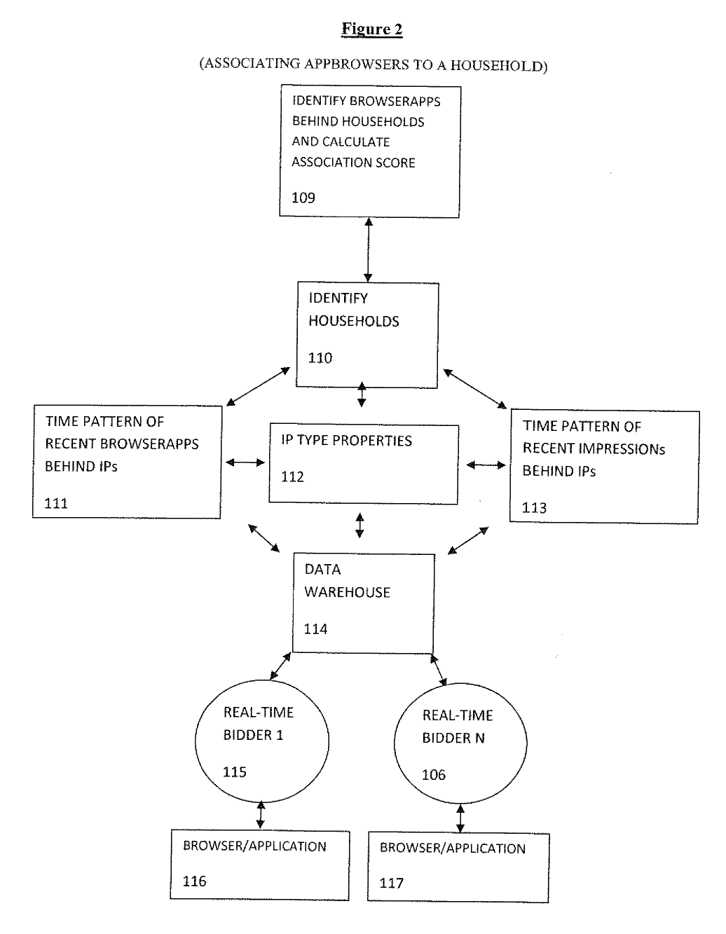

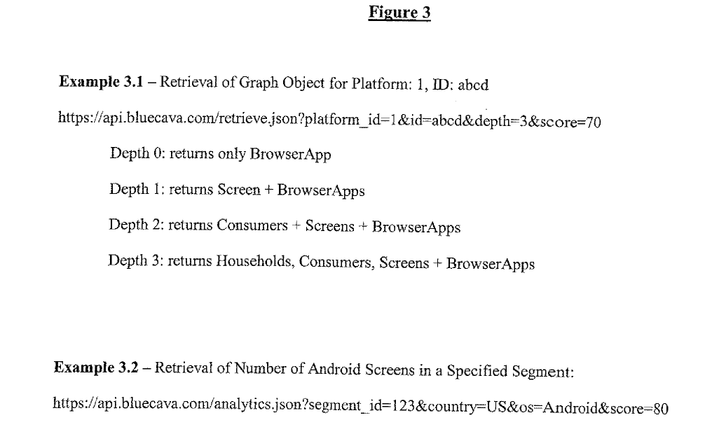

According to an embodiment of the disclosed subject matter and referring to FIG. 3, there are 2 representative API calls. In API call 3.1, an API user requests a graph object that matches identifier “abcd” belonging to platform 1. The user requests depth 3 of the graph that will return the entire group of associations as shown in FIG. 1. The API user in call 3.1 requests score 70 which will only return household, consumer, and screen objects that are thought to be highly correlated with the identifier passed in for the BrowserApp. In API call 3.2, an API user requests the number of android devices attached to a specific segment. The return value will be an integer representing the number of Android devices contained in that segment that are thought to be strongly associated with BrowserApp devices identified in that segment (score 80 and above).

According to an embodiment of the disclosed subject matter and referring to FIG. 4, a segment provider 101 or an advertiser or publisher 102 places an iframe or pixel within their App or Browser. The pixel or iframe passes an identifier for the segment plus an identifier for the BrowserApp to the data warehouse 103. The information is then stored and attached to a specific BrowserApp along with the data and time representing the last seen view of that device. Queries to the association graph can now be made using the identifier passed into the API. Also in FIG. 4, a bidder on an exchange may buy an impression on the exchange which will then place an iframe or pixel on the BrowserApp that will send data back to the data warehouse storing the exchange identifier or common identifier associated with the BrowserApp element into the association graph along with a date and time representing the last seen.

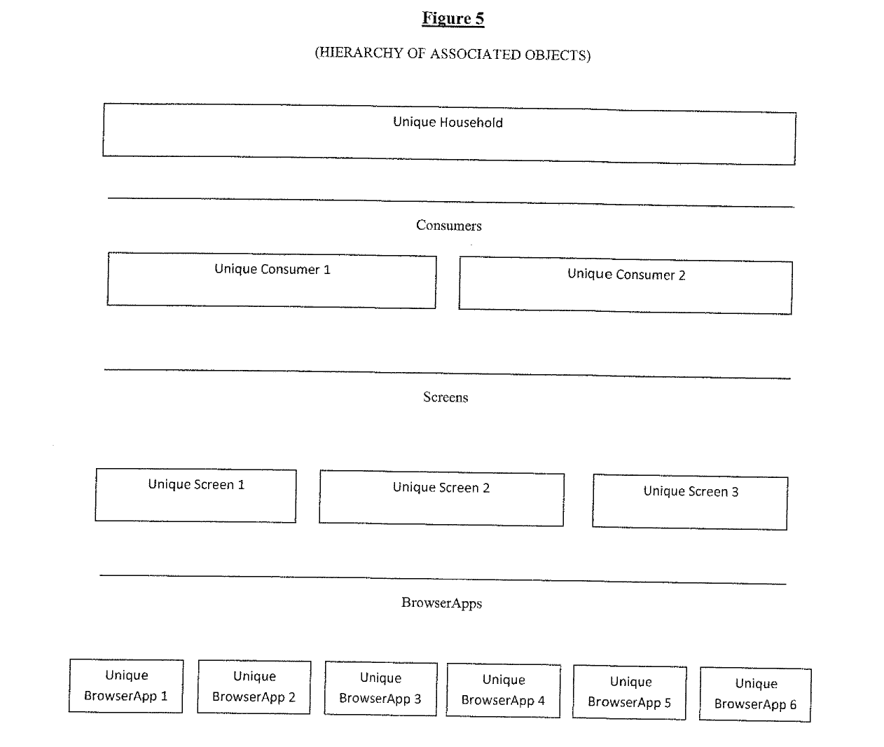

According to an embodiment of the disclosed subject matter and referring to FIG. 5, objects connected to a unique household are related in a hierarchical manner. One or more consumers may be related to a single household. A unique consumer may be related to one or more unique screens, possibly sharing them with other unique consumers. A unique screen may have one or more unique BrowserApps. But a unique BrowserApp can only be associated with a single unique Screen.

According to an embodiment of the disclosed subject matter, there are three association processes for the unique objects connected to a unique household: BrowserApp to Screen, BrowserApp to Consumer, and Screen to Consumer. The following three processes run after the identification of Households and after BrowserApps have been associated to Households.

First, an association is made between BrowserApps to screen. In this process, various pieces of information are used to infer the existence of different screens in a household. For example, the near simultaneous appearance of impressions in different locations for two BrowserApps signals that they belong to different screens. As another example, BrowserApp snapshots typically include device wide characteristics such as operating system, software versions, and installed fonts.

Second, an association is made between BrowserApps to consumer. In this process, various pieces of information are used to infer the existence of different consumers in a household. For example, the near simultaneous appearance of impressions in different locations for two BrowserApps signals they belong to two different consumers. As another example, the unsupervised clustering of URIs for BrowserApp impressions can identify distinct browsing patterns.

Third, an association is made between screen to consumer. In this process, using the association scores from the two previous processes (BrowserApp to Screen, BrowserApp to Consumer) we can calculate an association score from Screen to Consumer.

The methods described herein may be implemented on a variety of communication hardware, processors and systems known by those of ordinary skill in the computing arts. The various diagrams and flow charts described in connection with the embodiments disclosed herein may be implemented or performed in full or in part with a general purpose processor, digital signal processor, application specific integrated circuit, field programmable gate array, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller or state machine. A processor may also be implemented as a combination of any of the aforementioned computing devices.

The steps of a method, process, program, or algorithm described in connection with the embodiments disclosed herein may be embodied directly in hardware, in a software module executable by a processor, or in a combination of the two, e.g. as firmware. A software module may reside in memory such as RAM, ROM, EPROM, EEPROM, flash memory, registers, a hard disk, a removable disk, a CD-ROM, or another software module such as a web browser, or within any other form of storage medium known in the art for recording digital data. An exemplary storage medium may be coupled to the processor, such that the processor can read information from, and write information to, the storage medium. In the alternative, the storage medium may be integral to the processor. In a pure form, a method according to the disclosed subject matter may be software embodied as an electronic signal or series of electronic signals capable of being transmitted as information wirelessly or otherwise, for example, as a modulating signal receivable through a modem as a downloadable file or bit stream.

Exemplary embodiments of the disclosed subject matter have been disclosed in an illustrative style. Accordingly, the terminology employed throughout should be read in an exemplary rather than a limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A method for creating a scored device association graph comprising:
(a) monitoring a pattern of activity of a first object within a graph;
(b) recording the pattern of activity of the first object at a data warehouse;
(c) calculating an association score between the first object and a second object in the graph based on the pattern of activity; and
(d) storing the association score between the first object and the second object in a scored device association graph.

2. The method of claim 1 wherein the pattern of activity is a time pattern.

3. The method of claim 1 wherein the pattern of activity is a web browsing pattern.

4. The method of claim 1 wherein the first object is selected from the group consisting of: BrowserApp, screen, consumer, and household.

5. The method of claim I wherein the second object is selected from the group consisting of: BrowserApp, screen, consumer, and household.

6. The method of claim 1 wherein calculating an association score further comprises comparing the pattern of activity of the first object to a pattern of activity of the second object.

7. The method of claim 1 wherein calculating an association score further comprises comparing the pattern of activity of the first object to a pattern of activity of a third object.

8. The method of claim 7 wherein the third object is selected from the group consisting of: BrowserApp, screen, consumer, and household.

9. A computer system, comprising:
at least one processor;
at least one computer readable medium that is operatively coupled to the at least one processor; and
a logic that (i) executes in the at least one processor from the at least one computer readable medium and (ii) when executed by the at least one processor, causes the computer system to create a scored device association graph by at least:
(a) monitoring a pattern of activity of a first object within a graph;
(b) recording the pattern of activity of the first object at a data warehouse;
(c) calculating an association score between the first object and a second object in the graph based on the pattern of activity; and
(d) storing the association score between the first object and the second object in a scored device association graph.

10. The computer system of claim 9 wherein the pattern of activity is a time pattern.

11. The computer system of claim 9 wherein the pattern of activity is a web browsing pattern.

12. The computer system of claim 9 wherein the first object is selected from the group consisting of: BrowserApp, screen, consumer, and household.

13. The computer system of claim 9 wherein the second object is selected from the group consisting of: BrowserApp, screen, consumer, and household.

14. The computer system of claim 9 wherein calculating an association score further comprises comparing the pattern of activity of the first object to a pattern of activity of the second object.

15. The computer system of claim 9 wherein calculating an association score further comprises comparing the pattern of activity of the first object to a pattern of activity of a third object.

16. The computer system of claim 15 wherein the third object is selected from the group consisting of: BrowserApp, screen, consumer, and household.

17. A non-transitory computer readable storage medium comprising a set of executable instructions to direct a processor to:
(a) monitor a pattern of activity of a first object within a graph;
(b) record the pattern of activity of the first object at a data warehouse;
(c) calculate an association score between the first object and a second object in the graph based on the pattern of activity; and
(d) store the association score between the first object and the second object in a scored device association graph.

18. The non-transitory computer readable storage medium of claim 17 wherein calculate an association score further comprises compare the pattern of activity of the first object to a pattern of activity of the second object.

19. The non-transitory computer readable storage medium of claim 17 wherein calculate an association score further comprises compare the pattern of activity of the first object to a pattern of activity of a third object.
